(19) United States
(12) Patent Application Publication
(10) Pub. No.: US 2005/0201451 A1
(43) Pub. Date: Sep. 15, 2005

(54) Method and device for determining transmission parameters

(75) Inventors: Heinrich Schenk, Munich (DE); Joachim Schenk, Munich (DE)

Correspondence Address: Maginot, Moore & Beck;Bank One Tower, Suite 3000, 111 Monument Circle, Indianapolis, IN, 46204, US

(73) Assignee: Infineon Technologies AG, Munchen (DE)

(21) Appl. No.: 11/073,429

(22) Filed: Mar. 4, 2005

(30) Foreign Application Priority Data
Mar. 5, 2004 (DE) 10 2004 010874.9

(51) Int. Cl. H04B 1/38

(52) U.S. Cl. 375/219; 375/285

(57) ABSTRACT

The invention concerns a method and a device for determining parameters of a transmission link (2) which is connected to a transmission/reception device (1A; 1B) on the basis of an echo signal of a transmission signal which is transmitted onto the transmission link (2) with at least one individual pulse. The echo signal is first captured. The echo components of the echo signal are shortened by applying a preferably adjustable shortening filter (19) to the captured echo signal. The invention also proposes applying an adjustable further filter (18) to the echo signal, and adjusting the adjustable further filter (18) and preferably also the shortening filter (19) to select an effective central frequency of the at least one individual pulse. The parameters of the transmission link (2) are determined by evaluating the filtered echo signal on the basis of the temporal position and/or amplitude of at least the echo component from the end of the transmission link (2).

This invention concerns a method and a device for determining transmission parameters of a transmission link, e.g. in a telecommunication system.

Transmission parameters of a transmission link, e.g. line length and line attenuation, are usually determined by transmitting a signal at one end of the transmission link and evaluating the received signal at the other end of the transmission link. For this, it is necessary that the transmission link should be connected at its start and end to an appropriate measuring device. Particularly in the case of transmission links with a great geometrical extent, i.e. a great length, this represents a considerable cost.

To be able to avoid the use of a measuring device at both the start and the end of the transmission link, a method of determining transmission parameters is known, in which at one end of the transmission link a transmission signal with a periodic sequence of individual pulses is transmitted onto the transmission link, and at the same end of the transmission link a resulting echo signal is captured and evaluated. For this purpose, complex optimisation methods are usually necessary.

A simplified method of determining transmission parameters is known from DE 102 26 347 C1. According to this method, an echo component of the echo signal from the start of the transmission link and an echo component of the echo signal from the end of the transmission link are shortened by means of a shortening filter, preferably in the form of a digital differentiator, in such a way that the echo component from the end of the transmission link is no longer overlaid by the echo component from the start of the transmission link. In this way, it is possible to evaluate the echo component from the end of the transmission link regarding its temporal position and amplitude, so that the line length and line attenuation can be determined. To implement the method, it is provided that an appropriate transmission/reception device includes the shortening filter as the only filter in either a transmission path or a reception path of the transmission/reception device, or that the shortening filter is divided between the transmission path and reception path. To determine the line attenuation for different frequency values, i.e. to determine the frequency dependency of the line attenuation, it is necessary that a central frequency of the individual pulses which are transmitted onto the transmission link should be changed. This can be done by an appropriate setting of the symbol rate of the transmission signal, i.e. of the frequency corresponding to a temporal extent or symbol duration of an individual pulse, or by an appropriate choice of the parameters of the differentiator. Thus to determine the frequency dependency of the line attenuation, the echo signal for numerous different transmission signals and different parameters of the differentiator must be captured and evaluated. This means a considerable cost in time.

The object of this invention is to provide a method and a device which allow for a simplified determination of transmission parameters, and in particular of frequency-dependent signal attenuation, on a transmission link.

This object is achieved by a method according to Claim 1 and a device according to Claim 15. The dependent claims define preferred and advantageous embodiments of the invention.

In the method according to the invention of determining the parameters of a transmission link which is connected to a transmission/reception device, at least one transmission signal with at least one individual pulse is transmitted via the transmission link by means of a transmitter of the transmission/reception device, and an echo signal of the transmission signal is captured. The echo signal includes at least one echo component of the transmission signal from a start of the transmission link and one echo component of the transmission signal from an end of the transmission link. The echo components of the echo signal are shortened by applying a shortening filter to the captured echo signal. Additionally, the echo signal is filtered by an adjustable further filter, preferably a low-pass filter with adjustable cutoff frequency, e.g. in the form of a digital comb filter. To determine the parameters of the transmission link, the filtered echo signal is evaluated on the basis of the temporal position and amplitude of at least the echo component from the end of the transmission link. To select an effective central frequency of the at least one individual pulse of the transmission signal, the adjustable further filter, and preferably also the shortening filter, are adjusted.

In particular, the invention exploits the fact that the arrangement of the transmission/reception device and transmission link is substantially a linear system, and thus, by downstream filtering of the echo signal, the frequency which is relevant to evaluation, i.e. the effective central frequency of the at least one individual pulse of the transmission signal, can be selected without the actual central frequency of the at least one individual pulse being changed. It is thus possible to determine the parameters of the transmission link at different frequencies, without renewed transmission of a transmission signal and capture of the corresponding echo signal being required. This reduces the cost, particularly of determining the frequency-dependent signal attenuation on the transmission link, considerably. Additionally, because of the combination of the shortening filter and the adjustable further filter, a filtered echo signal, in which the temporal position and amplitude of the echo component from the end of the transmission link can be evaluated, is already achieved, so that no expensive correlation method is required and the result is further simplification compared with the prior art.

Preferably, to select the effective central frequency of the at least one individual pulse, the shortening filter is also adjusted. If the shortening filter includes a differentiator, the shortening filter can be adjusted by selecting the order of the differentiator. In this way, more flexible selection of the effective central frequency of the individual pulse is made possible.

It is also advantageous if, in the case of the method according to the invention, the captured echo signal is stored by storage means, e.g. in the form of a digital memory, and repeatedly evaluated as described above for different effective central frequencies of the at least one individual pulse. In this way, the parameters of the transmission link are determined for multiple frequencies, without additional transmission of transmission signals and capture of the corresponding echo signal being required.

In the method according to the invention, multiple transmission of transmission signals with at least one individual pulse via the transmission link, and capture of the corresponding echo signals, can be provided. By such multiple measurement events or capture events, the influence of measurement errors can be limited, e.g. on the basis of a statistic framework. Additionally, if the individual pulses of the multiply transmitted transmission signals each have different central frequencies, the frequency range in which the parameters of the transmission link can be determined can be extended.

In the method according to the invention, depending on the temporal position of the echo component from the end of the transmission link, the length of the transmission link can be determined. Depending on the amplitude of the echo component from the end of the transmission link and on the set effective central frequency, the frequency-dependent signal attenuation on the transmission link can be determined. For this purpose, preferably an envelope function of the filtered echo signal is calculated. The envelope function is preferably an even power of the envelope of the filtered echo signal. To calculate the envelope of the filtered echo signal, preferably the Hilbert transform of the filtered echo signal is calculated. By calculating the envelope function of the filtered echo signal, the temporal position and amplitude of the echo component from the end of the transmission link can be precisely determined by simple means.

In the method according to the invention, the echo signal can be captured using a receiver of the transmission/reception device or using an echo compensation device of the transmission/reception device. Whereas in the first case the echo signal is captured directly, in the latter case coefficients of the echo compensation device are read out, and represent the echo signal with a precision depending on the adaptation of the echo compensation device. Thus through the adaptation of the echo compensation device, the echo signal can be captured simultaneously.

The invention also concerns a device to determine parameters of a transmission link which is connected to a transmission/reception device, depending on the echo signal of a transmission signal which is transmitted onto the transmission link with at least one individual pulse. The echo signal has at least one echo component of the transmission signal from a start of the transmission link, and one echo component of the transmission signal from an end of the transmission link. According to the invention, the device includes a signal input to receive a captured echo signal, a preferably adjustable shortening filter to shorten the echo components of the captured echo signal, and an adjustable further filter to filter the captured echo signal. By adjusting the adjustable further filter, and preferably also the shortening filter, an effective central frequency of the at least one individual pulse of the transmission signal can be selected. The device according to the invention also includes evaluation means to evaluate the filtered echo signal to determine the parameters of the transmission link on the basis of the temporal position and amplitude of at least the echo component from the end of the transmission link. The signal input can be connected, for instance, to a means of capturing the echo signal, e.g. a receiver of the transmission/reception device or an echo compensation device of the transmission/reception device. The device is preferably designed to carry out the method described above, and for this purpose it can include, for instance, storage means to store the captured echo signal, calculation means to calculate an envelope function of the filtered echo signal, or adjustment means to adjust the shortening filter and/or the adjustable further filter to select an effective central frequency of the individual pulse of the transmission signal.

The device according to the invention is particularly suitable as a part or component of a transmission/reception device for a telecommunication system. Such a transmission/reception device is able, with little additional cost, to determine, for instance, the length or frequency-dependent signal attenuation of the transmission link.

This invention has the advantage that the parameters of the transmission link, particularly the frequency-dependent signal attenuation on the transmission link, can be determined simply. Particularly because of the possibility of evaluating the captured echo signal for different effective central frequencies of the individual pulse of the transmission signal, the time cost for determining the frequency dependency of the signal attenuation on the transmission link can be significantly reduced. In determining the length of the transmission link, because of the multiple evaluation with different parameters the certainty of the evaluation can be increased, e.g. by rejecting evaluations with a result which differs from the majority of the evaluation results. Separate calculation of correlation functions, e.g. a cross-correlation function or auto-correlation function, is unnecessary with this invention, because a similar effect is simply achieved by the combination of the shortening filter with the adjustable further filter.

The invention is explained in more detail below, on the basis of preferred embodiments and with reference to the attached drawings.

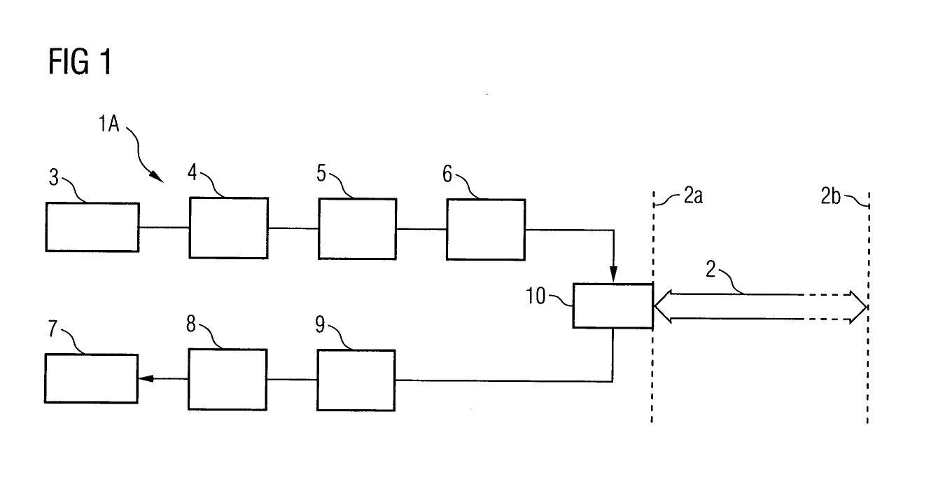

FIG. 1 shows a suitable arrangement for use of this invention, consisting of a transmission/reception device and a transmission link;

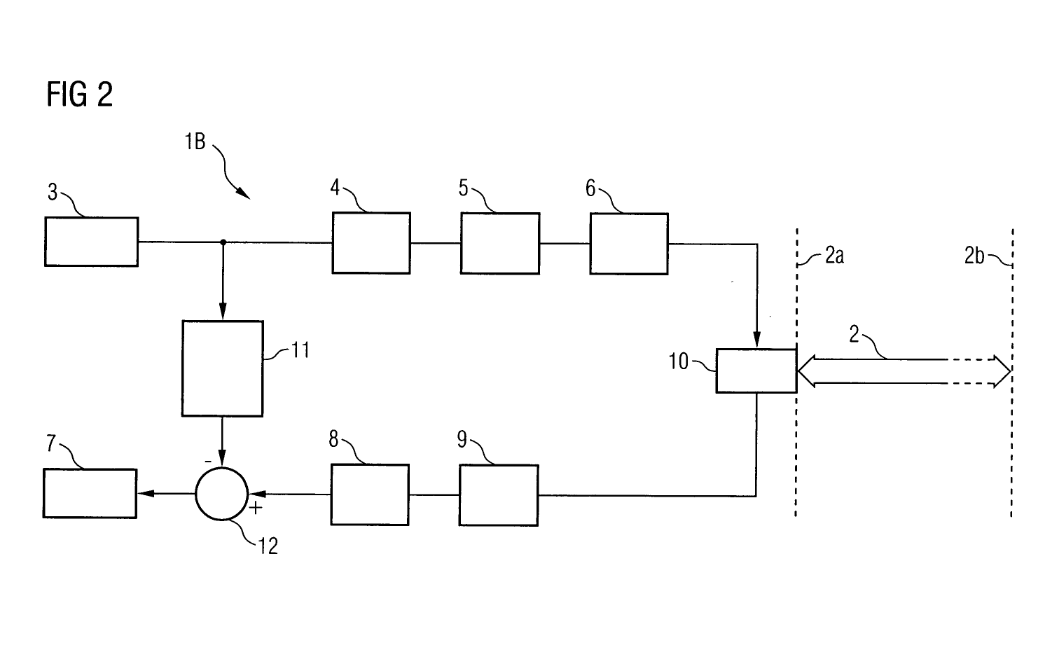

FIG. 2 shows an arrangement which is similar to the arrangement of FIG. 1, and in which the transmission/reception device includes an echo compensation device;

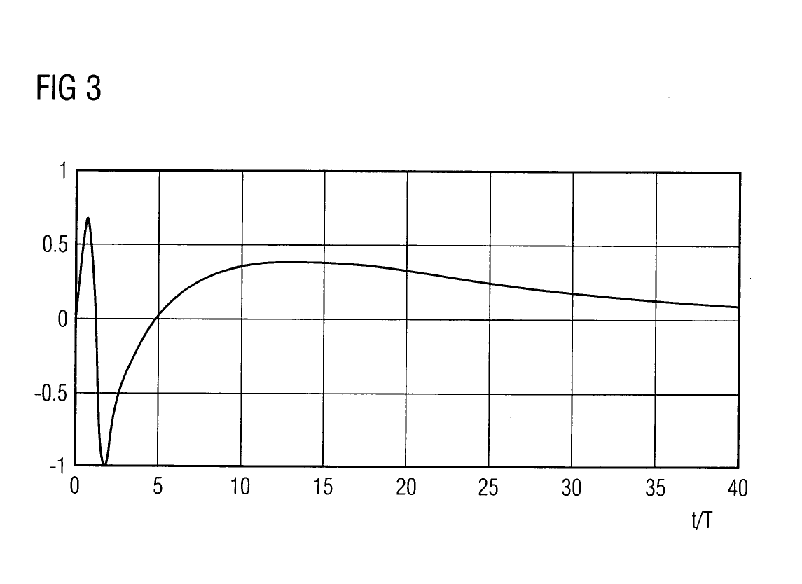

FIG. 3 shows, as an example, an echo signal or echo pulse response in the case of an arrangement as in FIG. 1 or FIG. 2;

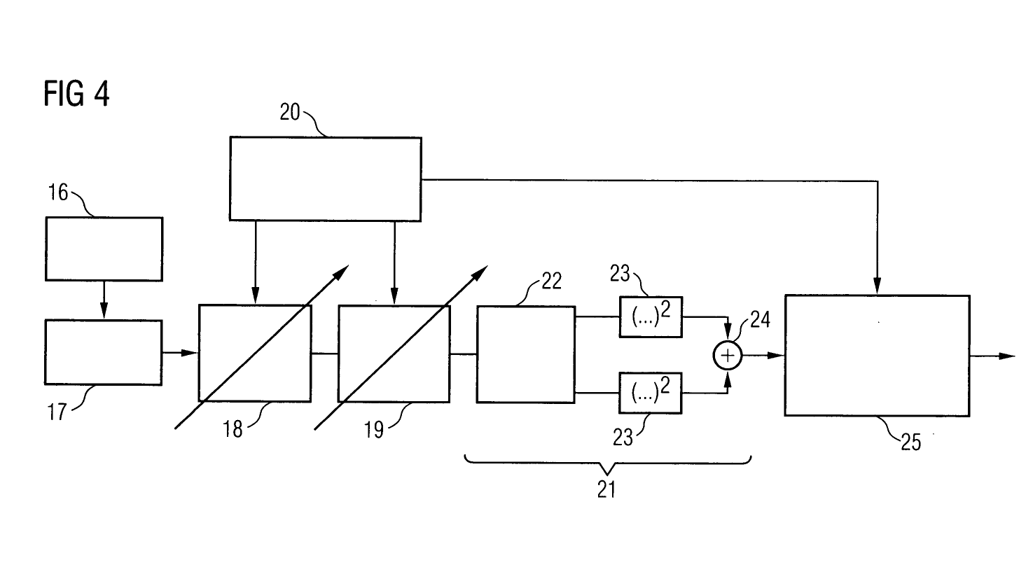

FIG. 4 shows a device for determining parameters of a transmission link according to an embodiment of the invention;

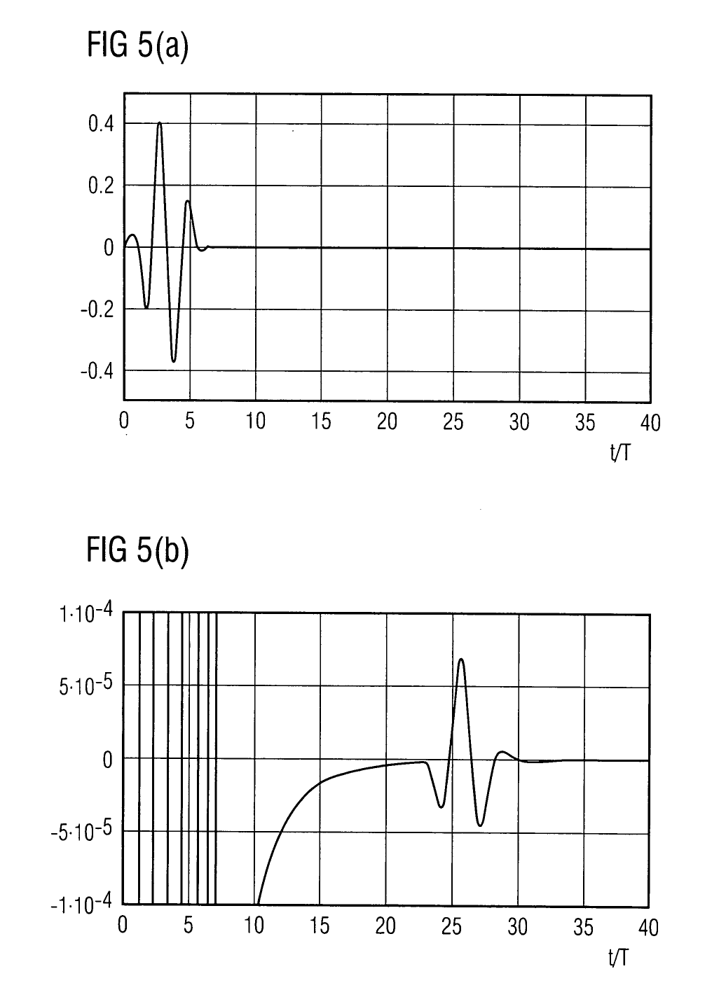

FIG. 5(a) shows the echo signal of FIG. 3 after filtering by a shortening filter;

FIG. 5(b) shows the echo signal of FIG. 5(a), enlarged 5,000-fold;

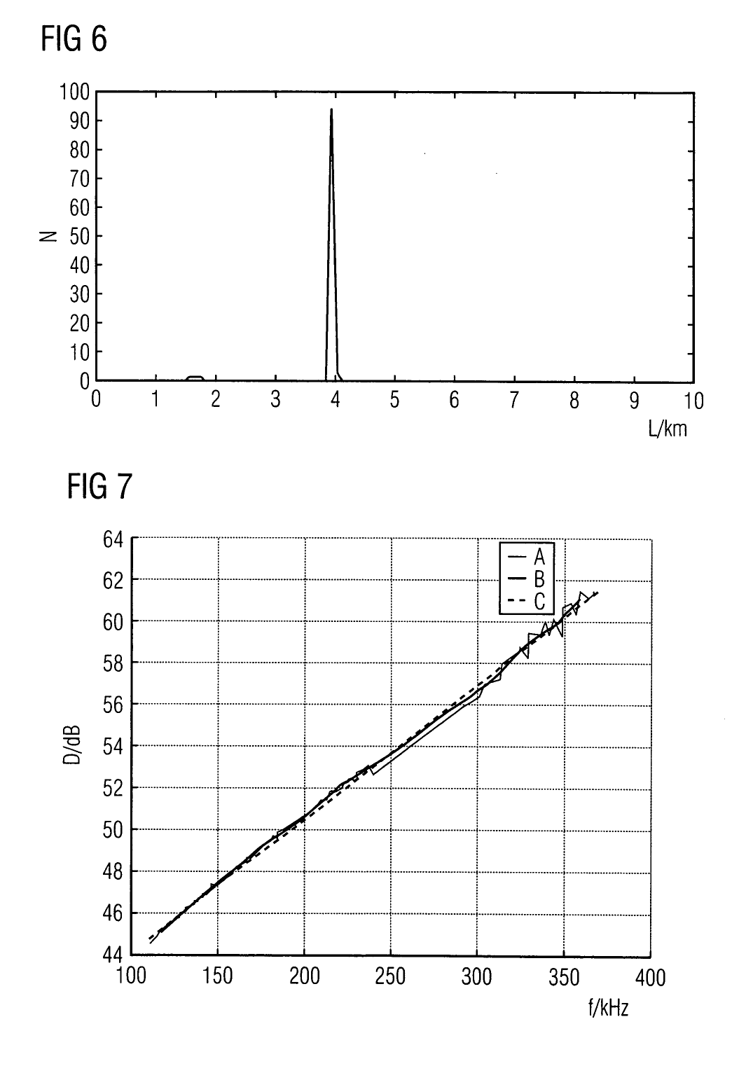

FIG. 6 shows an example of a frequency distribution of lengths of a transmission link, determined according to an embodiment of the invention from an echo signal with different filter settings; and

FIG. 7 shows, as an example, a frequency dependency of the signal attenuation of the transmission link of FIG. 6, determined according to the embodiment of the invention.

FIG. 1 shows schematically an arrangement in a telecommunication system consisting of a transmission/reception device 1A and a transmission link 2. The transmission/reception device 1A includes, in a transmission branch, a transmitter 3, a transmission filter 4, a digital/analog converter 5 and a transmission amplifier 6. In a reception branch, the transmission/reception device 1A includes an analog/digital converter 9, a reception filter 8 and a receiver 7. The transmission branch and reception branch of the transmission/reception device 1A are connected via a hybrid 10 to a transmission link 2. Dashed lines in FIG. 1 indicate the start 2a and end 2b of the transmission link 2.

An individual pulse which is transmitted via the transmitter 3 onto the transmission link 2 calls up an echo signal, which can be captured in the receiver 7 of the transmission/reception device 1A. The echo signal is caused by transmission properties, which change on the transmission link 2 of a transmission medium, e.g. an electrical line. Such changes of transmission properties of the transmission medium occur, in particular, at the start 2a and end 2b of the transmission link 2, and each correspond to an echo component of the echo signal. An echo component from the start 2a of the transmission link 2 is often called a near-end echo, and an echo component from the end 2b of the transmission link 2 is often called a far-end echo.

FIG. 2 shows another arrangement, consisting of a transmission/reception device 1B and a transmission link 2. The arrangement corresponds substantially to the arrangement shown in FIG. 1. Similar elements are therefore marked with the same reference symbols and are not explained again below. In contrast to the transmission/reception device 1A of FIG. 1, the transmission/reception device 1B of FIG. 2 includes an echo compensation device 11, which is connected between the transmission branch and the reception branch of the transmission/reception device 1B. The echo compensation device 11 which is shown in FIG. 2 corresponds to a digital echo compensation device, i.e. the transmission branch couples a digital transmission signal into the echo compensation device 11, where it is modified. The modified transmission signal is subtracted from a reception signal in a superimposition point 12 in the reception branch of the transmission/reception device 1B, so that the echo signal is largely eliminated from the reception signal. For this purpose, the modifications which take place in the echo compensation device 11 include, in particular, attenuating and delaying the transmission signal. Corresponding attenuation and delay coefficients of the echo compensation device 11 are set adaptively depending on the properties of the transmission link. One way in which the adaptive setting or adaptation of the echo compensation device 11 can take place, for instance, is that as the transmission signal a stochastic symbol sequence is transmitted, and the coefficients of the echo compensation device 11 are adapted so that the echo signal is minimised. With ideal adaptation of the echo compensation device 11, i.e. if the echo signal is completely eliminated from the reception signal, the signal which the echo compensation device 11 generates corresponds to the echo signal, i.e. the echo signal can be represented by the coefficients of the echo compensation device. With the arrangement shown in FIG. 2, it is thus possible to capture the echo signal by means of the echo compensation device 11.

As an example, FIG. 3 shows an echo signal for a transmission/reception device as in FIG. 2, as a function of the time t in units of a symbol length T. As the transmission link, a 3.5 km long line of diameter 0.4 mm is used, and the transmission signal includes individual pulses with a baud rate of 640 kilobaud. However, in FIG. 3 only the echo component from the start 2a of the transmission link 2 can be detected, whereas the echo component from the end 2b of the transmission link 2 is overlaid by the echo component from the start 2a of the transmission link 2. The echo component from the start 2a of the transmission link 2 has a many times greater amplitude than the echo component from the end 2b of the transmission link 2.

FIG. 4 shows a device for determining parameters of a transmission link according to an embodiment of the invention. The device includes a signal input 16, via which a digitally captured echo signal is fed to the device. The device also includes a digital memory 17, in which the captured echo signal from the signal input 16 is stored and can be called up for multiple processing in the device. To process the echo signal, the device includes an adjustable shortening filter 19 and an adjustable further filter 18. The adjustable shortening filter 19 includes a digital filter with the transmission function
H_{Diff}(z)=(1−z^{-2·w}^{_{Comb}}^{·w}^{_{Diff}})ⁿ^{_{Diff}}.

z designates a complex frequency parameter which is defined by

$$z = {ⅇ}^{j \cdot 2 \cdot π \cdot \frac{f}{{f}_{A}}} .$$

f_{A} designates the sampling frequency of the shortening filter 19 and of the adjustable further filter 18. The sampling frequency f_{A} is an integer multiple of the baud rate (symbol rate) with which the transmission signal is transmitted, i.e. the following applies:
f_{A}=k·f_{T},
where f_{T} designates the baud rate or symbol rate. For k, various integer values can be chosen. In this embodiment, k=2, which simplifies the implementation of the device.

The adjustable further filter includes a digital comb filter with the transmission function

$${H}_{Comb} ( z ) = {( \frac{1 - {z}^{- {w}_{Comb}}}{1 - {z}^{- 1}} )}^{{n}_{Comb}} .$$

The adjustable shortening filter 19 thus represents an n_{Diff}-fold differentiator, and the adjustable further filter represents a low-pass filter with adjustable cutoff frequency. With the parameters w_{Comb}, n_{Comb} and w_{Diff}, an effective central frequency of an individual pulse of the transmission signal can be varied within wide ranges. Varying the effective central frequency means that the relevant frequency range of the individual pulse of the transmission signal for evaluating the parameters of the transmission link is varied.

The device shown in FIG. 4 also includes means to calculate an envelope function (in the form of an envelope function means 21) of the echo signal which is filtered by the shortening filter 19 and the adjustable further filter 18. The envelope function means 21 includes a Hilbert transformation means 22 and squaring elements 23. The envelope E(t) of a signal s(t) can be specified as follows:
E(t)={square root over ((s(t))²+(H(s(t)))²)}.

H(s(t)) designates the Hilbert transform of the signal s(t). For simplicity, in this embodiment the square of the envelope is calculated as the envelope function:
(E(t)²=(s(t))²+(H(s(t)))².

This is done by calculating the Hilbert transform of the echo signal in the Hilbert transformation block 22, calculating the square of the Hilbert transform in one of the squaring elements 23, calculating the square of the echo signal in the other of the squaring elements 23, and superimposing the squared Hilbert transform and the squared echo signal in the superimposition point 24. Thus in this case, the envelope function is the square of the envelope of the filtered echo signal, but higher even powers of the envelope can also be used. The envelope function of the filtered echo signal is fed to an evaluation means 25, which evaluates the length of the transmission link and the signal attenuation from the envelope function, i.e. from the position of the maximum of the envelope function and the value of the maximum. To determine the signal attenuation, the maximum of the envelope function is set in relation to a reference value, which corresponds to an unattenuated individual pulse at the start of the transmission link. This reference value can be determined by a single reference measurement on a known transmission link or determined by a computer simulation. Since this reference value, at a given signal strength of the transmission signal, depends only on the properties of the transmission/reception device, once a reference value has been determined it can be specified for many transmission/reception devices of the same type, and does not have to be determined again by a reference measurement or simulation.

The Hilbert transform of the filtered echo signal can be calculated in various ways. In particular, the implementations which are presented in DE 102 26 347 C1 can be used to calculate the Hilbert transform.

The device which is shown in FIG. 4 also includes a control means 20, which controls the adjustment of the adjustable shortening filter 19 and adjustable further filter 18. In this way, the above-mentioned parameters w_{Comb}, n_{Comb} and w_{Diff}, n_{Diff} are varied, to select different effective central frequencies. The value of the effective central frequency is made available to the evaluation means 25, so that in the evaluation means 25, parameters of the transmission link 2 can be determined depending on the frequency. An echo signal which is stored in the memory 17 is called up many times, and processed with different settings of the parameters of the adjustable shortening filter 19 and adjustable further filter 18.

When the device of FIG. 4 is used to carry out a method according to an embodiment of this invention, the signal input 16 is connected to a receiver 7 or an echo compensation device 11 of the transmission/reception device 1A or 1B of FIG. 1 or 2 respectively, so that echo signals are fed to the device of FIG. 4 for further processing. To determine the parameters of the transmission link 2, at least once a transmission signal is transmitted by means of the transmitter of the transmission/reception device 1A or 1B onto the transmission link 2, and the corresponding echo signal is captured. However, multiple transmission of the transmission signal can also take place, in which case, in particular, the symbol rate and thus the actual central frequency of individual pulses of the transmission signal can be varied. In this way, on the one hand the frequency range for frequency-dependent determination of parameters of the transmission link 2 can be extended, and on the other hand the effect of measurement errors can be reduced.

To capture the echo signal, the sampling frequency f_{A} is chosen taking into account the sampling theorem. Here this means specifically that the sampling frequency f_{A} corresponds to at least twice the symbol rate f_{T}. As mentioned above, in the case of this embodiment it is assumed that the sampling frequency f_{A} corresponds to twice the symbol rate f_{T}. In the case of transmission/reception devices of which the digital components work with the symbol rate f_{T}, the echo signal can only be captured corresponding to the symbol rate f_{T}. In this case, to achieve a sampling frequency f_{A} which corresponds to twice the symbol rate f_{T}, the echo signal is captured twice with initial phases shifted by T/2. If this is done using an echo compensation device such as the echo compensation device 11 in FIG. 2, the coefficients of the echo compensation device must be read out twice, and to generate the final echo signal which is suitable for further processing, the coefficients must be put together alternately in the correct sequence from the two coefficient sets.

FIG. 5(a) shows as an example the echo signal of FIG. 3 when a shortening filter in the form of a four-fold differentiator is used. The course of the filtered echo signal is shown as a function of the time t in units of the symbol length T. In a starting area, the echo component from the start of the transmission link, i.e. the near-end echo, can be seen. The temporal extent of the near-end echo is very limited in comparison with FIG. 3.

FIG. 5(b) shows the course of the filtered echo signal of FIG. 5(a), enlarged 5,000-fold. It can be seen that the echo component from the end 2b of the transmission link 2, i.e. the far-end echo, is resolved separately from the near-end echo, and thus can be evaluated regarding its position and amplitude.

Below, results, which were gained on the basis of a computer simulation, of the method of determining parameters of the transmission link are explained. The echo signal of a 4 km long electrical line with a core diameter of 0.4 mm was evaluated. The echo signal was based on a symbol rate of 800 kilobaud. The length of the transmission link, i.e. the line length, and the signal attenuation on the transmission link were evaluated with a total of one hundred different parameter settings of the adjustable shortening filter 19 and adjustable further filter 18.

FIG. 6 shows a frequency distribution of the determined values for the line length L. The evaluation was based on a signal propagation speed in the cable of 185,000 k.p.s. The absolute frequency N of determined line lengths L is shown. It can be seen that with most parameter settings (97 settings) a line length of about 4 km was determined. However, some settings (3) correspond to a line length of about 1.7 km. These results are interpreted as evaluation errors and rejected. In particular, these results are not taken into account in the further determination of the frequency-dependent line attenuation, to avoid a resulting falsification of the frequency dependency.

FIG. 7 shows the course of the frequency-dependent line attenuation D depending on the frequency f, as determined according to the described method. The thin continuous line A shows the values determined according to the method. The thick continuous line B shows an average of the course A over six points in each case. Additionally, the course calculated on the basis of the above-mentioned line parameters is shown as a thick dashed line C. It can be seen that the course which is determined on the basis of the method steps described above agrees very well with the calculated course of the line attenuation. To determine the course, only one captured echo signal was required. The effort of determining the frequency dependency of the attenuation with the described method is thus extremely low, in particular regarding the capture of the echo signal.

1-21. (canceled)

22. A method of determining parameters of a transmission link which is connected to a transmission/reception device, the method comprising:
(a) transmitting at least one transmission signal with at least one individual pulse via the transmission link;
(b) capturing at least one echo signal of the at least one transmission signal, the echo signal including a first echo component of the transmission signal from a start of the transmission link and a second echo component of the transmission signal from an end of the transmission link;
(c) shortening the first echo component and the second echo component of the echo signal by applying a shortening filter to the captured echo signal;
(d) filtering the captured echo signal by an adjustable further filter;
(e) adjusting the adjustable further filter to select an effective central frequency of the at least one individual pulse of the transmission signal, and
(f) evaluating the filtered echo signal to determine the parameters of the transmission link on the basis of a temporal position and/or an amplitude of at least the second echo component.

23. The method according to claim 22 wherein the shortening filter is adjustable, and wherein step (e) further comprises adjusting the adjustable shortening filter.

24. The method according to claim 22 wherein the at least one individual pulse of the at least one transmission signal comprises a plurality of different effective central frequencies, the method further comprising the steps of
storing the captured echo signal; and
carrying out steps (c) to (f) repeatedly for the plurality of different effective central frequencies of the at least one individual pulse.

25. The method of claim 22 wherein the at least one transmission signal comprises multiple transmission signals each with at least one individual pulse, and corresponding echo signals of the multiple transmission signals are captured.

26. The method of claim 25 wherein the individual pulses of the multiple transmission signals each have different central frequencies.

27. The method of claim 22 wherein the adjustable further filter includes a low-pass filter with adjustable cutoff frequency.

28. The method of claim 27 wherein the low-pass filter with adjustable cutoff frequency is a comb filter.

29. The method of claim 22 wherein the shortening filter includes a differentiator.

30. The method of claim 22 wherein the length of the transmission link is determined on the basis of the temporal position of the second echo component.

31. The method of claim 22 wherein a frequency-dependent signal attenuation on the transmission link is determined on the basis of the amplitude of the second echo component and of the effective central frequency.

32. The method of claim 22 wherein, in order to determine the temporal position and/or amplitude of at least the second echo component, an envelope function of the filtered echo signal is calculated.

33. The method of claim 32 wherein, in order to calculate the envelope function of the filtered echo signal, a Hilbert transform of the filtered echo signal is calculated.

34. The method of claim 22 wherein the echo signal is captured by means of a receiver of the transmission/reception device.

35. The method of claim 22 wherein the echo signal is captured by means of an echo compensation device of the transmission/reception device.

36. A device operable to determine parameters of a transmission link which is connected to a transmission/reception device on the basis of an echo signal of a transmission signal transmitted onto the transmission link with at least one individual pulse, the echo signal including a first echo component of the transmission signal from a start of the transmission link and a second echo component of the transmission signal from an end of the transmission link, the device comprising:
a signal input operable to receive a captured echo signal;
a shortening filter operable to shorten the echo components of the captured echo signal;
an adjustable further filter operable to filter the captured echo signal, wherein adjustment of the adjustable filter is operable to affect an effective central frequency of the at least one individual pulse of the transmission signal; and
means for evaluating the filtered echo signal to determine the parameters of the transmission link on the basis of a temporal position and/or an amplitude of at least the second echo component.

37. The device of claim 36 further comprising a storage operable to store the captured echo signal.

38. The device of claim 36 further comprising means for calculating an envelope function of the filtered echo signal.

39. The device of claim 36 further comprising means for adjusting the adjustable further filter to select the effective central frequency of the at least one individual pulse of the transmission signal.

40. The device of claim 36 wherein the shortening filter is adjustable and the device includes means for adjusting the shortening filter.

41. The device of claim 36 wherein the device is included in a telecommunication system.
